(19) United States
(12) Patent Application Publication
(10) Pub. No.: US 2006/0078475 A1
(43) Pub. Date: Apr. 13, 2006

(54) Modular microfluidic packaging system

(76) Inventors: Yu-Chong Tai, Pasadena, CA (US); Scott Miserendino, Pasadena, CA (US); Qing He, Pasadena, CA (US); Siyang Zheng, Pasadena, CA (US)

Correspondence Address: FOLEY AND LARDNER LLP;SUITE 500, 3000 K STREET NW, WASHINGTON, DC, 20007, US

(21) Appl. No.: 11/192,434

(22) Filed: Jul. 29, 2005

Related U.S. Application Data
(60) Provisional application No. 60/592,588, filed on Jul. 29, 2004.

(51) Int. Cl. G01N 27/447; B01L 11/00

(52) U.S. Cl. 422/102; 204/600; 422/99

(57) ABSTRACT

A packaging system for microfluidics including a microfluidic modular packaging system comprising: a packaging jig comprising a body, at least two module ports for placing microfluidic modules, at least one external fluidic port, and at least one internal fluidic port; at least two die platforms adapted to fit into the module ports and move the microfluidic modules; at least one fluidic control die; at least one circuit board, and at least one cover. HPLC applications are particularly important for proteomics research and commercialization.

### CROSS-REFERENCE TO RELATED PATENT APPLICATIONS

The present application claims priority to U.S. provisional patent application No. 60/592,588 “Modular Microfluidic Packaging System” to Tai et. al. filed Jul. 29, 2004, which is incorporated hereby by reference in its entirety for all purposes.

### STATEMENT FOR FEDERALLY FUNDED RESEARCH

The work herein was developed with the following finding: National Science Foundation, grants NCC2-1364 and CCR-0121778.

### BACKGROUND

An increasing interest exists in use of microfluidic systems for biological and chemical applications. One of the most attractive features of microfluidic systems is their ability to integrate a series of sequential operations on a single device. However, a development of highly efficient, fully integrated device can be a very difficult, multivariable problem. Consequently, to establish some baseline parameters for the design of an optimized device, sequential operations are usually developed and characterized in a discrete manner before the device's integration. This approach allows one to divide the problem into many smaller and much more manageable tasks and deal with them individually. Still, it is often difficult to test each component of the device in isolation before attempting the integration, as many of them do not provide meaningful information before they are incorporated into the system as a whole. Thus, it is highly desirable to develop a modular microfluidic packaging system which will allow one to incorporate separately developed microfluidic components in an integrated device.

The modular microfluidic system should satisfy one or more of the following general goals or requirements: (1) the system should provide both electrical and fluidic connections between multiple separately developed microfluidic components and the outside environment; (2) the system should allow easy replacement of broken or outdated components; (3) the system should place minimum constraints on individual component design, fabrication and material selection; (4) individual parts of the system should be chemically inert and compatible with a wide variety of fluids; (5) external connections, both fluidic and electrical, should be through standard connectors or stand alone wires; and/or (6) the system should provide maximum visibility of operation of the constituent microfluidic components.

The present invention provides several designs of modular microfluidic packaging systems which satisfy many of the above goals or requirements. Integration of multiple microfluidic devices remains difficult because there does not exist a standardized port scheme or packaging design that allows individual devices or modules to interoperate.

### SUMMARY

One embodiment provides a microfluidic modular packaging system comprising: (i) a packaging jig comprising a body, at least two module ports for placing microfluidic modules, at least one external fluidic port, and at least one internal fluidic port; (ii) at least two die platforms adapted to fit into the module ports and move the microfluidic modules, (iii) at least one fluidic control die; (iv) at least one circuit board, and (v) at least one cover.

Another embodiment provides a microfluidic modular packaging system comprising: a packaging jig, said packaging jig comprising (i) a body having at least two module ports for placing microfluidic modules; (ii) external fluidic ports; and (iii) internal fluidic ports; wherein said body comprises a plurality of channels providing fluid communication between said external and internal fluidic ports and not providing fluid communication between said microfluidic modules. Not having fluid communication between microfluidic modules in the packaging jig can allow one to reduce a dead, or unused, volume in the modular microfluidic packaging system. The packaging system can further comprise a control die having a front surface and a back surface, wherein the front surface of said control die comprises a plurality of microchannels providing fluid communication between said two or more modules and/or between said microfluidic modules and the internal fluidic ports of said jig.

Also provided is a microfluidic system comprising: (A) a jig comprising: (i) external fluidic ports, (ii) internal fluidic ports, and (iii) a jig body comprising a plurality of channels providing fluidic communication between said external and internal fluidic ports; (B) a microfluidic die comprising: (i) a substrate having a front surface and a back surface, (ii) microfluidic ports on the front surface, wherein said microfluidic ports do not extend from said front surface to said back surface, and (iii) a plurality of channels on the front surface, wherein said channels provide microfluidic communication between said microfluidic ports; and wherein said microfluidic die is disposed on the jig so that said microfluidic ports of the die match internal fluidic ports of the jig.

### BRIEF DESCRIPTION OF THE DRAWINGS

FIG. 1 shows a cross-section view of control die fabrication process flow.

FIG. 2 shows engineering drawings for a PEEK jig body in a primary design, showing front, back, top, and bottom views.

FIG. 3 shows an engineering drawing for a PEEK jig body, perspective view.

FIG. 4 shows an engineering drawing for an acrylic cover including front view, top view, and isometric view.

FIG. 5 shows an engineering drawing for a PEEK die platform including front, bottom, and isometric views.

FIG. 6 shows an engineering drawing for a PCB hole layout.

FIG. 7 shows an engineering drawing for a fluidic control die hole layout.

FIG. 8 shows an engineering drawing for a micromachined generic die layout for use in designing microfluidic modules which can be adapted to a fluidic control die.

FIG. 9 shows an engineering drawing for a primary modular fluidic packaging, perspective view, exploded, including four microfluidic modules.

FIG. 10 shows an engineering drawing for an alternative design: stacked modular fluidic packaging.

FIG. 11 shows an engineering drawing for an alternative design: reduced modular fluidic packaging.

FIG. 12 shows an engineering drawing for an alternative design: wirebonding modular fluidic packaging.

FIG. 13 shows an engineering drawing for an alternative design: clear top modular fluidic packaging.

FIG. 14 shows a photograph, perspective view, of an assembled microfluidic modular packaging system of the primary design.

FIG. 15 shows a photograph, top view, of an assembled microfluidic modular packaging system of the primary design.

FIG. 16 shows a photograph, side view, of an assembled microfluidic modular packaging system of the primary design.

FIG. 17 shows a photograph, side view, of an assembled microfluidic modular packaging system of the primary design.

FIG. 18 shows a photograph of the microfluidic modular packaging system of the primary design.

FIG. 19 shows a photograph of the microfluidic modular packaging system of the primary design.

FIG. 20 shows a photograph of the microfluidic modular packaging system of the primary design.

FIG. 21 shows a photograph of the microfluidic modular packaging system of the primary design.

FIG. 22 shows a photograph of the microfluidic modular packaging system of the primary design.

FIG. 23 shows an exploded view of the microfluidic modular packaging system of the primary design.

FIG. 24 shows an engineering drawing of a PCB hole and contact pad layout.

FIG. 25 shows a fluidic control die hole layout.

FIG. 26 shows a PEEK body engineering drawing.

FIG. 27 shows a PEEK die platform engineering drawing.

FIG. 28 shows a photograph of a front side of the PCB board used in the primary design of the microfluidic modular packaging system.

FIG. 29 shows a photograph of a back side of the PCB board used in the primary design of the microfluidic modular packaging system.

FIG. 30 shows a process flow for making a control die for a modular microfluidic packaging system.

### DETAILED DESCRIPTION OF THE PREFERRED EMBODIMENTS

I. Introduction

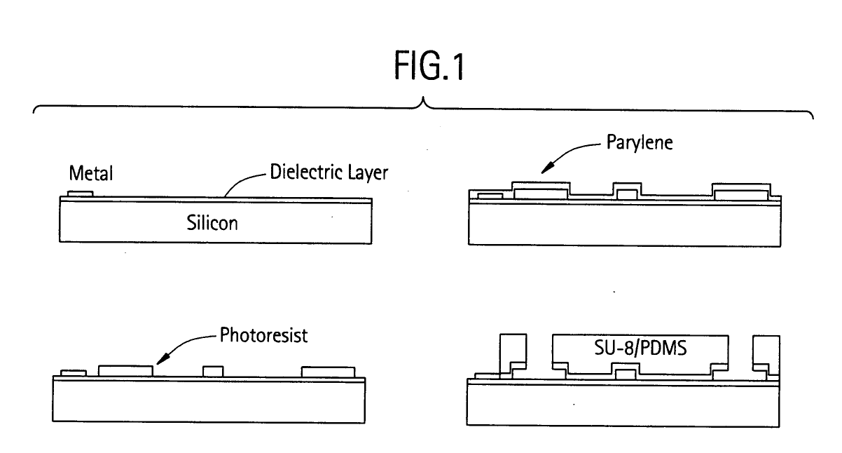

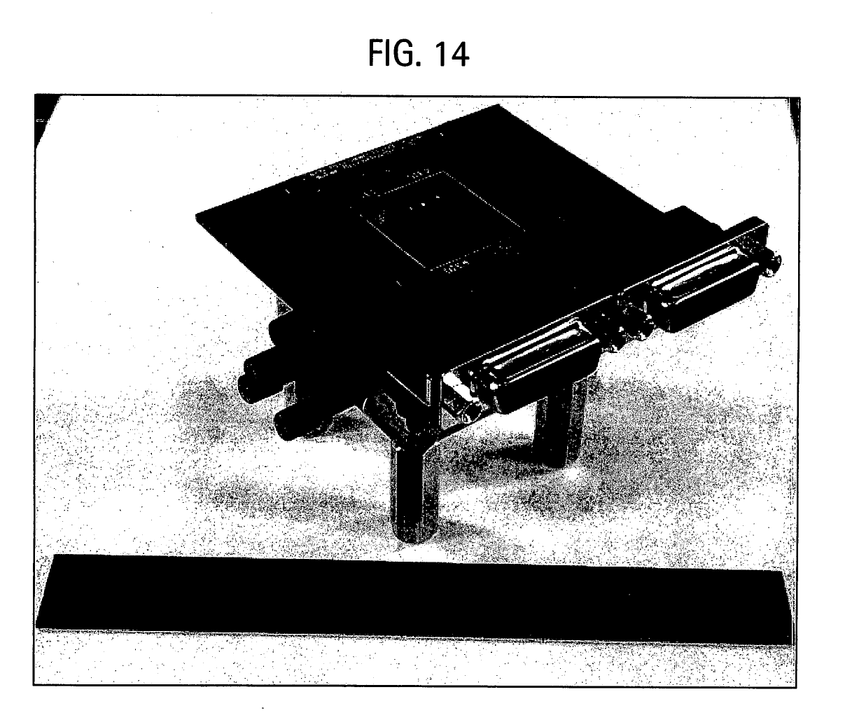

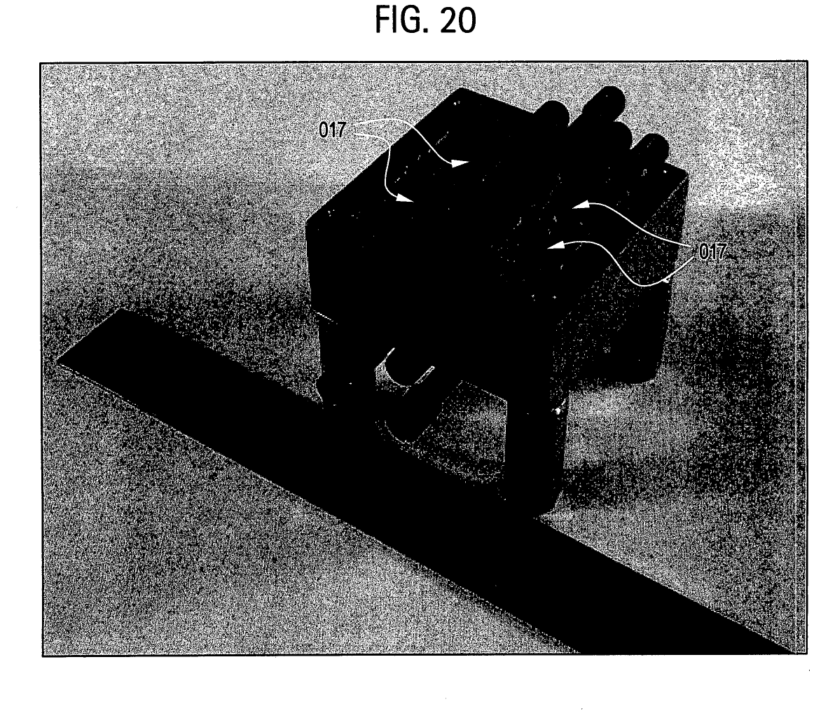

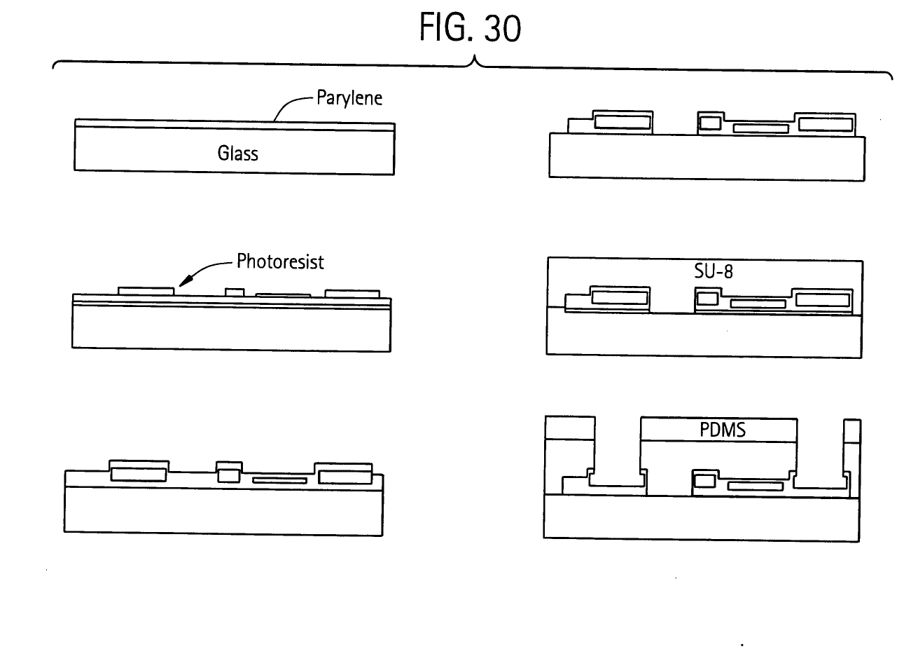

Priority U.S. provisional patent application No. 60/592,588 “Modular Microfluidic Packaging System” to Tai et. al. filed Jul. 29, 2004, is incorporated hereby by reference in its entirety for all purposes including all drawings and figures, which are provided herein as FIGS. 1-13. FIGS. 14-30 provides further description.

The following related patent documents can be useful for understanding and practicing this invention:

(i) US patent application publication No. 2005-0051489 “IC-processed Polymer Nano-liquid Chromatography System” by Tai et. al. published Mar. 10, 2005, incorporated hereby by reference in its entirety;

(ii) US patent application publication No. 2003-0228411 “A Method for Integrating Micro- and Nanoparticles Into MEMS and Apparatus Including the Same” by Tai et. al. published Dec. 11, 2003, incorporated hereby by reference in its entirety;

(iii) U.S. patent application Ser. No. 09/442,843 (CIT 2887) “Polymer Based Electrospray Nozzle for Mass Spectrometry” by Tai et. al. filed Nov. 18, 1999, incorporated hereby by reference in its entirety;

(iv) US patent application publication No. 2004-0124085 “Microfluidic Devices and Methods with Electrochemically Actuated Sample Processing” by Tai et. al. published Jul. 1, 2004, incorporated hereby by reference in its entirety;

(v) US patent application publication No. 2004-0237657 “Integrated Capacitive Microfluidic Sensors Method and Apparatus” by Tai et. al. published Dec. 2, 2004, incorporated hereby by reference in its entirety;

(vi) US patent application publication No. 2004-0188648 “Integrated Surface-Machined Micro Flow Controller Method and Apparatus” to Xie et. al. published Sep. 30, 2004, incorporated hereby by reference in its entirety;

(vii) U.S. patent application Ser. No. 11/059,625 (CIT 4046) “On-Chip Temperature Controlled Liquid Chromatography Methods and Devices” by Tai et. al. filed Feb. 17, 2005, incorporated hereby by reference in its entirety;

(viii) U.S. Pat. No. 5,994,696 (CIT 2569) “MEMS Electrospray Nozzle for Mass Spectroscopy” to Tai et. al. issued Nov. 30, 1999, and incorporated hereby by reference in its entirety;

(ix) U.S. Pat. No. 6,436,229 “Gas phase silicon etching with bromine trifluoride” to Tai et. al. issued Aug. 20, 2002, and incorporated hereby by reference in its entirety;

(x) U.S. Pat. No. 6,162,367 “Gas phase silicon etching with bromine trifluoride” to Tai et. al. issued Dec. 19, 2002, and incorporated hereby by reference in its entirety;

(xi) U.S. provisional patent application No. ______, (CIT 4333P) “Wafer Scale Solid Phase Packing” filed Mar. 18, 2005 to Xie, Young, and Tai, incorporated hereby by reference in its entirety;

(xii) U.S. provisional application No. ______ (CIT 4350P) “Integrated Chromatography Devices and Systems for Monitoring Analytes in Real Time,” filed Apr. 14, 2005, to Xie, Young, and Tai, incorporated hereby by reference in its entirety;

Additional references which can provide background for practice of the present embodiments include U.S. Pat. Nos. 6,548,895; 6,827,095; 6,880,576; 2004/0228771; 2005/0051489; 3,548,849; 5,580,523; 5,640,995; and 6,536,477.

II. Overview of System, FIGS. 1-11

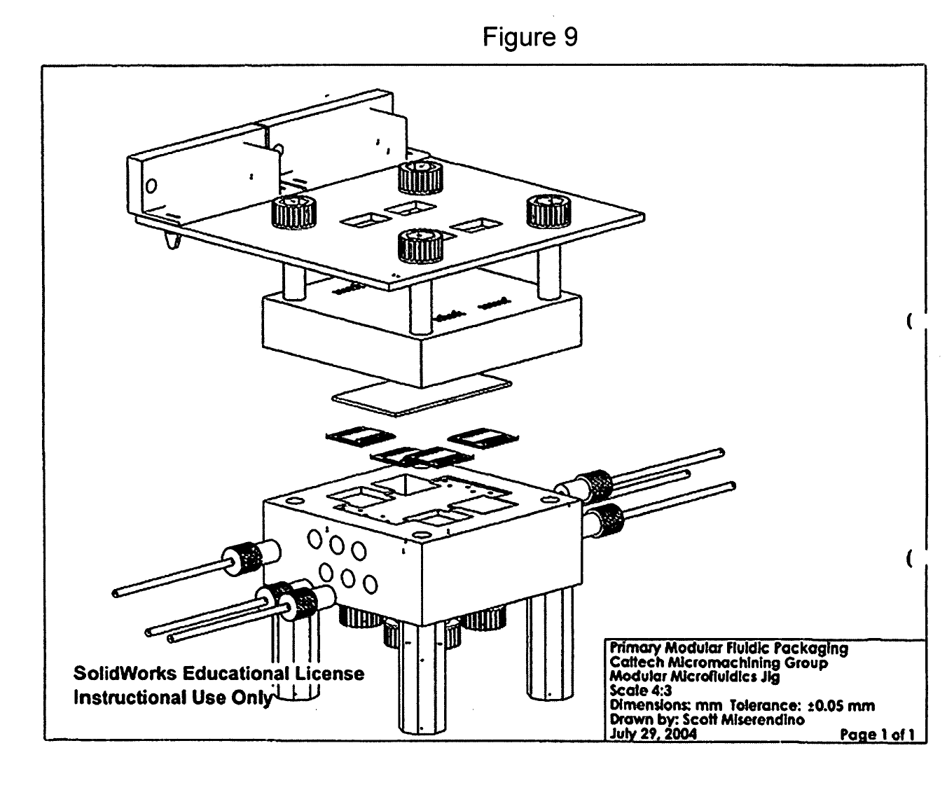

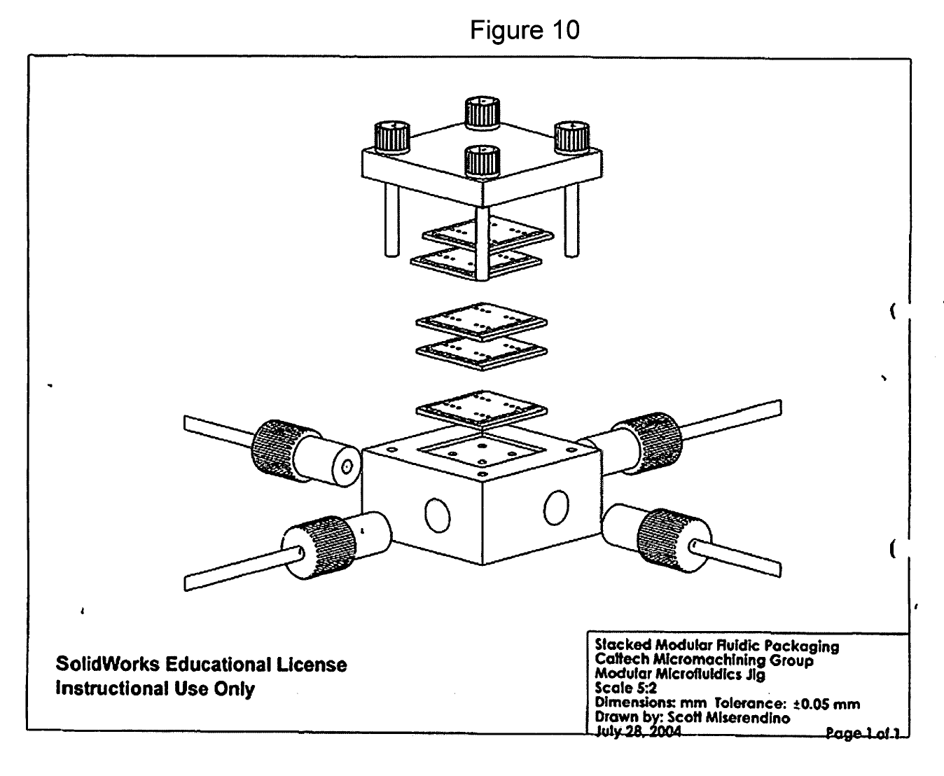

Embodiments described herein allow for the development of microfluidic device modules to be integrated on a single platform with all fluidic and electrical connections both to other modules and to devices outside the system. In particular, a primary design is shown in FIG. 9 showing elements of the system. Other non-primary designs are shown in FIGS. 10-13 and are described further below which supplement the primary design.

The microfluidic modular packaging system can be a kit comprising multiple separate components which are adapted to function together and assembled together to form a single functioning system. These components can include, for example, a plurality of microfluidic modules, a packaging jig, at least one die platform, a control die, a circuit board, and a cover.

In particular, provided is a microfluidic modular packaging system comprising:

a packaging jig comprising a body, at least two module ports for placing microfluidic modules, at least one external fluidic port, and at least one internal fluidic port;

at least two die platforms adapted to fit into the module ports and move the microfluidic modules,

at least one fluidic control die;

at least one circuit board, and

at least one cover.

In particular, one embodiment provides a microfluidic modular packaging system comprising: a packaging jig comprising a body, at least two module ports for placing microfluidic modules, at least one external fluidic port, and at least one internal fluidic port; at least two die platforms adapted to fit into the module ports; at least one translation device for moving the die platforms with respect to the packaging jig; at least one circuit board; and at least one cover.

The microfluidic modular packaging system can further comprise a control die having a front surface and a back surface, wherein the front surface of said control die comprises a plurality of microchannels providing fluid communication between said two or more modules and/or between said microfluidic modules and the internal fluidic ports of said jig.

Microfluidic modules are adapted to function with this system and can be provided with or separately from the system.

The die platforms can be moved by, for example, a translation stage and screws.

Auxiliary components include screws such as #10-32 screws, connectors such as high density D-subminiature right-angle connectors, probes such as double ended semiconductor probes (pogo pegs), standoffs such as ⅜ inch hex standoffs, nuts such as PEEK tubing nuts, ferrules such as Tefzel flangless ferrules, and tubing such as Teflon tubing. The tubing, nuts, ferrules combine to provide an interface to outside fluidic systems. The PCB board, HD-D sub connectors, and pogo pegs provide an interface to outside electrical systems.

The cover can be an acrylic cover which houses the pogo pegs and provides a transparent surface to compress the system.

The body and die platforms can be made of PEEK and allow device modules to be compressed against the fluidic control die from below by turning their individual screws.

The standoffs can be added to provide easy access to the bottom screws and allow attachment to outside housings.

III. Microfluidic Modules

Microfluidic modules are known in the art, and the present embodiments are not particularly limited by the type of microfluidic module as long as they are adapted to function with the packaging jig, control die, and other system components. For example, references (i) to (viii) noted above describe microfluidic modules including methods of making them. The microfluidic modules can be chips designed for liquid chromatography and include elements such as pumps, injection ports, columns, or detectors which are useful for liquid chromatography. The microfluidic modules can be adapted to couple with the packaging jig, the control die, and other components described herein. For example, the modules can comprise inlets and outlets for fluidic coupling. The inlets and the outlets can be on the top side of the module so that they can couple with the control die. The backside of the module can be free from inlets and outlets so that they can better interface with the die platforms are designed for movement and not for fluid flow.

The number of microfluidic modules is not particularly limited provided that generally the advantages of the present invention are achieved when two or more microfluidic modules are used. For example, the number can be two, three, four, five, six, seven, eight, nine, ten, eleven, or twelve, or can be, for example, 2-12, 2-20, 2-30, 2-40, or 2-50. The system can be set up so that each microfluidic module provides a separate function to the overall system. For example, one module can provide a pump and another module can provide a separation column. FIG. 9 illustrates a prototype system showing four microfluidic modules.

Each of the individual microfluidic modules can be fabricated in a manner similar to the fabrication of the control die, further described below. The individual microfluidic module can comprise a substrate having a front and a back surface and have a plurality of microchannels and a plurality of contact pads microfabricated on the front surface. Similar to the control die, the microchannels of the individual microfluidic module can comprise a pin free, chemically inert polymer such as parylene. The substrate of the individual microfluidic module can be made of semiconductor, such as silicon, or glass. To provide a better seal, all or a part of the front surface of the microfluidic module can have a planarizing layer comprising, for example, photoresist such as SU-8. Preferably, the planarizing layer can cover an area of the front surface surrounding its fluidic ports. The front surface of the individual microfluidic module can further comprise a polymer layer comprising, for example, photodefinable polymer such as PDMS. This polymer layer can act as a sealing gasket. The polymer layer can be placed on the top of the planarizing layer in the area of the microfluidic modules front surface that surrounds fluidic ports of the microfluidic device. The fluidic access to the microchannels on the individual microfluidic module can be provided through the fluidic ports. These fluidic ports can be similar to the ‘through’ holes of the control die, i.e. they can extend through the planarizing and/or sealing polymer layers to the microchannels but not through the thickness of the substrate.

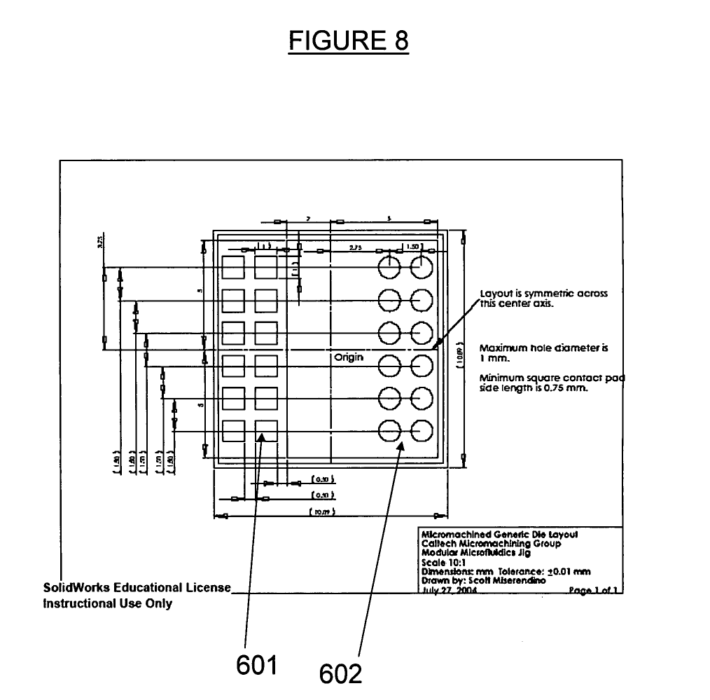

The contact pads on the individual microfluidic module can comprise, for example, Ti, Pt, Au, Pd, Cr, Cu, Ag, carbon, graphite, pyrolyzed carbon or a combination thereof. If a conducting material, such as silicon, is used as the substrate for the individual microfluidic module, an electrical isolation layer can be provided beneath the contact pads. A layout of the fluidic ports and contact pads on the individual microfluidic module is illustrated in FIG. 8 for one exemplary embodiment.

IV. Packaging Jig

An embodiment provides a microfluidic modular packaging system comprising:

two or more microfluidic modules;

a packaging jig, said packaging jig comprising (i) a body having module ports for placing said microfluidic modules; (ii) external fluidic ports; (iii) internal fluidic ports;

wherein said body comprises a plurality of channels providing fluid communication between said external and internal fluidic ports and not providing fluid communication between said microfluidic modules. Not having fluid communication between microfluidic modules can allow one to reduce a dead volume, or unused volume, of the modular system and therefore can be one of the advantages of a particular system.

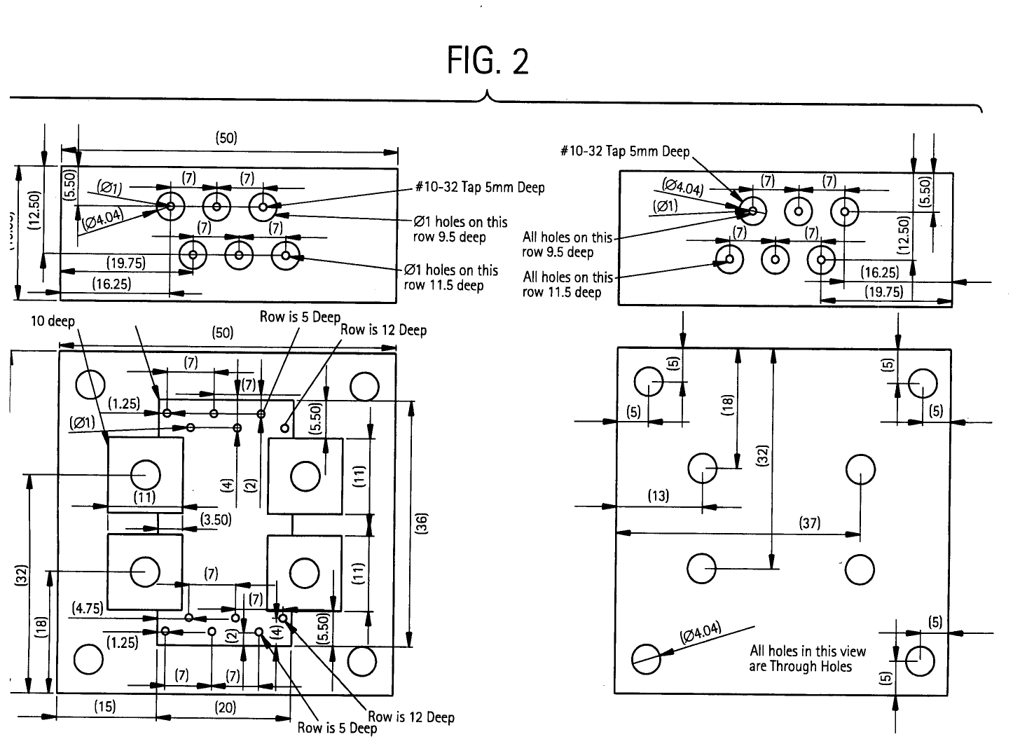

In addition to the microfluidic modules, another important element is the packaging jig, shown in FIGS. 2, 3, and 9, for example. The packaging jig comprises a body which is machined to have useful features including module ports, external fluidic ports, and internal fluidic ports. The structure of the body is not particularly limited although a generally cubic structure is generally preferred.

The body of the jig can be made, for example, with an engineering plastic such as, for example, a high glass transition temperature polymer such as polyetherether ketone (PEEK™). The material can be made of materials which are machinable, sturdy, chemically inert, and solvent resistant. Synthetic polymers can be used including those with high crystallinity. Optically transparent materials such as polycarbonate can be used.

The external fluidic ports can be part of an interface to outside fluidic systems. The external fluidic ports can serve both for letting one or more fluids into the microfluidic modular packaging system from the outside fluidic systems and for letting fluids out from the modular system. The external fluidic ports can be coupled to the outside fluidic system using standard fluidic connectors such as PEEK tubing, Tefzel flangless ferrules and Teflon tubing.

The internal fluidic ports of the modular system for bringing one or more fluids to and from microfluidic modules.

V. Die Platform

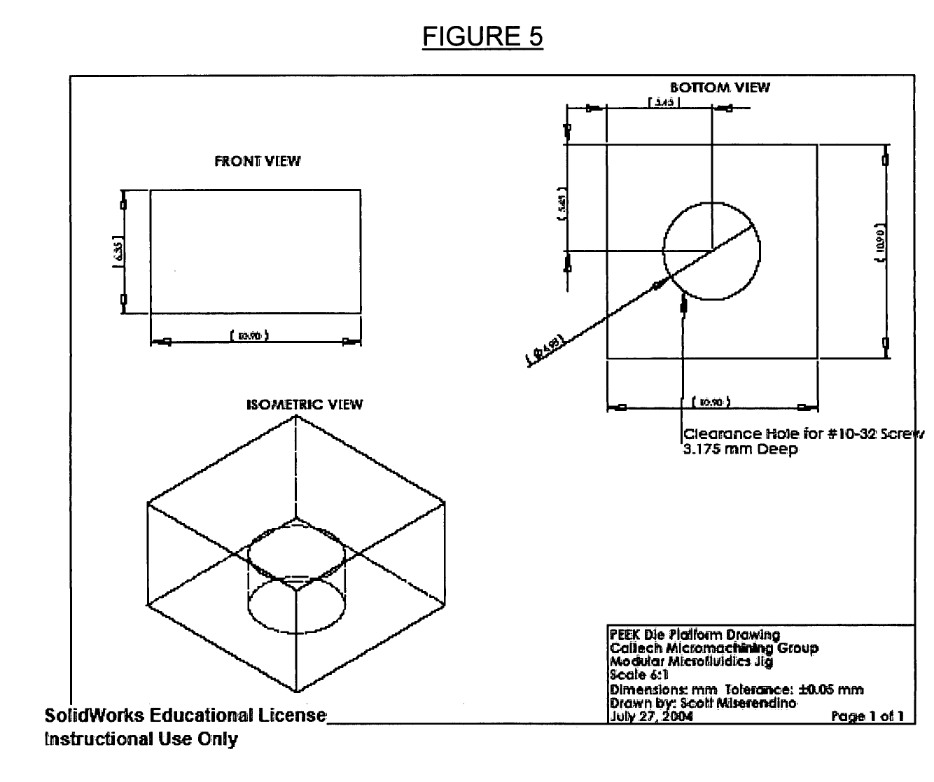

FIG. 5 provides an illustration of the die platform. The die platform is adapted in shape and size to fit into the module port and to have the ability to move up and down in the module port. The bottom view shows a clearance hole having a depth and adapted for screws to fit into the hole to move the die platform. The die platform can be made of chemically inert materials, including high temperature engineering plastics and synthetic polymers such as PEEK or polycarbonate (as with the jig). The die platform is also adapted to engage with screws or other motion or translation devices.

In a preferred embodiment, each translational device or stage can comprise a platform and a screw. The platform can comprise a chemically inert material such as polyetheretherketone. The individual microfluidic module can be placed with the back surface of the module facing the platform. Turning the screw can push the platform with the module up and down. The screw of the translational stage can also press the microfluidic module against the control die, thus, placing the fluidic ports of the individual microfluidic module in fluid communication with the through holes of the control die. Pressing the individual microfluidic module against the control die can also provide electrical connection to the module, by placing the contact pads of the module in contact with electrical probes. Individual translational stage provided for each microfluidic module can allow one to test a device on each module individually or in any desired combination with other modules of the modular microfluidic system.

To provide an easier access to the screws of the translational stages, the jig can be placed on standoffs. The standoffs can also allow attachment to outside housing.

VI. Control Die

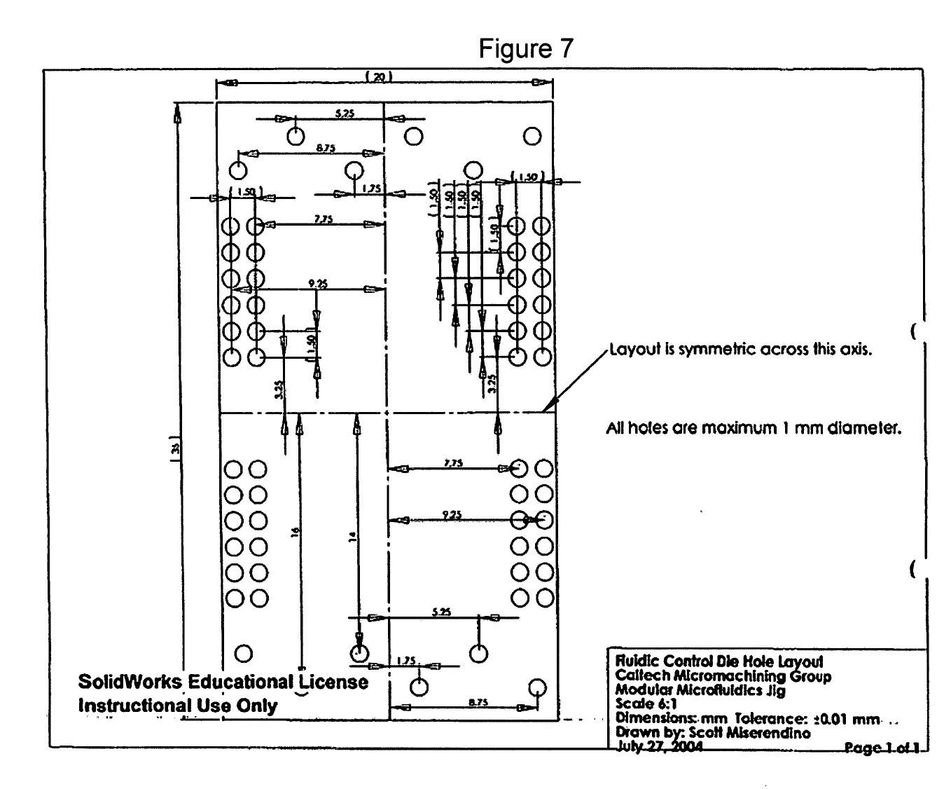

The fluidic control die provides microfluidic connections between the various modules. A design is provided in FIG. 7, and a method of making the control die is shown in FIG. 1.

The microfluidic modular packaging system can further comprising a control die having a front surface and a back surface, wherein the front surface of said control die comprises a plurality of microchannels providing fluid communication between said two or more modules and/or between said microfluidic modules and the internal fluidic ports of said jig.

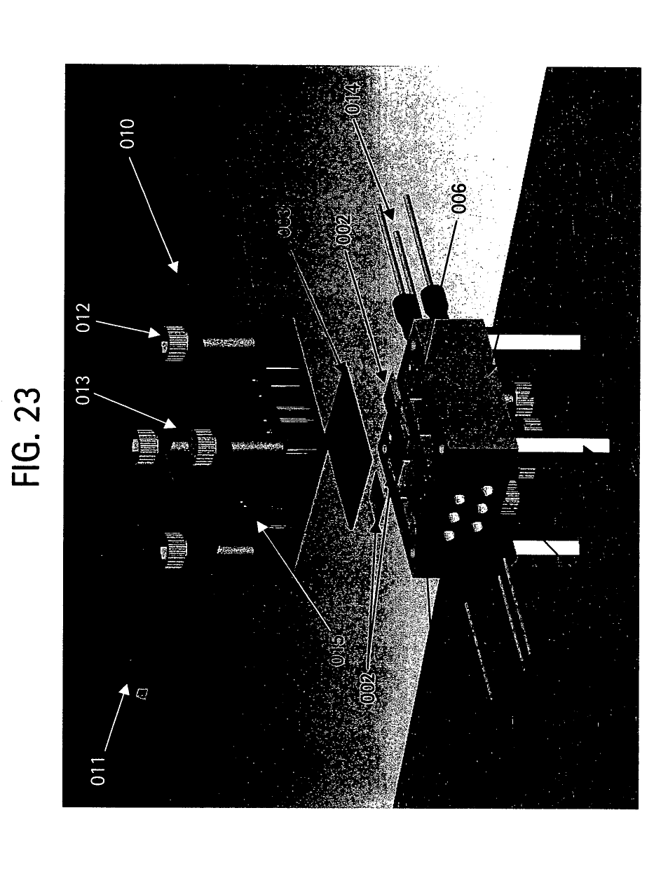

The modular microfluidic packaging system can further comprise a fluidic control die 003, as shown in FIG. 23, that can provide microfluidic connections between various microfluidic modules and between microfluidic modules and the internal fluidic ports of the modular system.

The control die can be a substrate having a front side and a back side and have a plurality of microchannels microfabricated on the front side. The substrate of the control die can be made of a semiconductor, such as silicon, or glass. The microchannels on the control die can be made by lithographic processes utilizing sacrificial photoresist. Walls of the microchannels can comprise a pin-hole free, chemically inert polymer such as parylene or polyimide.

To provide the microfluidic connections, the control die can be placed so that its front side is facing the internal fluidic ports of the jig. When the modular device is assembled, the control die can be compressed against the body of the jig or against the microfluidic module. To provide a better seal, the front side of the control die can have a planarizing layer comprising, for example, photoresist or epoxy material such as SU-8. The front surface of the control die can further comprise a sealing layer of polymer, for example, photodefinable polymer such as polydimethylsiloxane (PDMS) or other synthetic polymers and elastomers which act as a gasket.

In some embodiments of the invention, the modular system of the invention can comprise a polymer layer manufactured separately from the control die. This separate layer can also comprise PDMS or other photodefinable polymer.

The fluidic access to the microchannels on the front side of the control die can be provided via holes made through the planarizing and/or sealing layer. These “through” holes, however, do not extend through the thickness of the substrate. The absence of the holes that extend side to side of the control die's substrate (e.g., backside through holes) can be an advantage of the present modular system. This can make manufacturing easier, as manufacturing of side to side holes can be expensive, particularly when multiple holes have to be produced close to each other. The above mentioned ‘through’ holes can be placed on the control die to match on one hand, a layout of the internal fluidic ports on the body of the jig, and, on the other, a layout of fluidic ports on the individual microfluidic module. The system is engineered so that holes in the control die match holes in the microfluidic module and internal holes on the jig. This allows fluid communication between these three elements.

FIG. 1 illustrates a cross-section view of a control die fabrication process flow using silicon, metal, dielectric layer, photoresist, parylene, and SU-8, PDMS.

VII. Circuit Board

The modular microfluidic packaging system can also comprise a circuit board, including a printed circuit board (PCB), having external electrical connectors and internal electrical connectors. The internal electrical connectors can be electrically coupled to the contact pads microfluidic modules using electrical probes such as pogo pegs, i.e. double ended semiconductor probes. A separate set of internal connectors can be provided on the PCB board for each individual microfluidic module. The external connectors on the PCB board can be preferably standard electrical connectors, such as high density D-subminiature right-angle connectors. The PCB board can comprise one or more viewing ports for looking at the microfluidic modules. The PCB board can be attached to the body of the jig, for example, using screws. These screws can extend through the body of the jig to the standoffs.

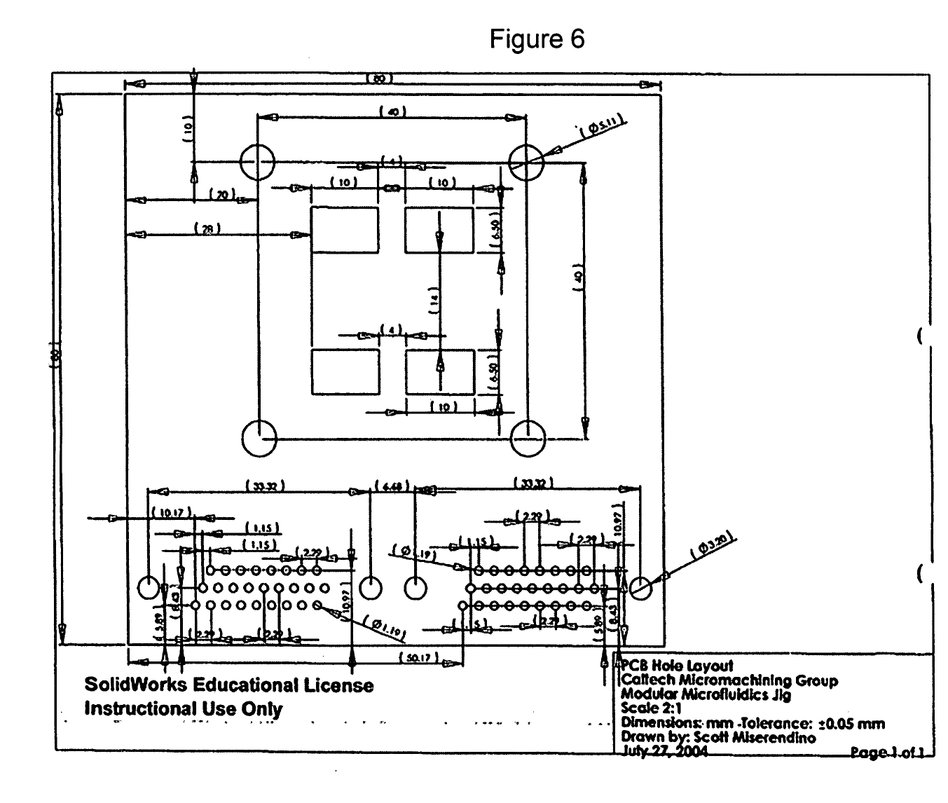

FIG. 6 shows an example of a PCB hole layout.

VIII. Cover

The modular microfluidic packaging system can also comprise a cover placed between the PCB board and the jig. The cover can comprise a transparent material, such as acrylic glass, to allow viewing of the microfluidic modules. The cover can be have side to side holes for the electric probes connecting the internal connectors of the PCB board and the contact pads of the microfluidic modules. The cover can also have side to side holes for the screws tightening the PCB board to the body of the jig. When the screws are tightened, the cover presses the control die against the body of the jig forming a seal in fluidic connection between the internal fluidic ports of the jig and the ‘through’ holes of the control die.

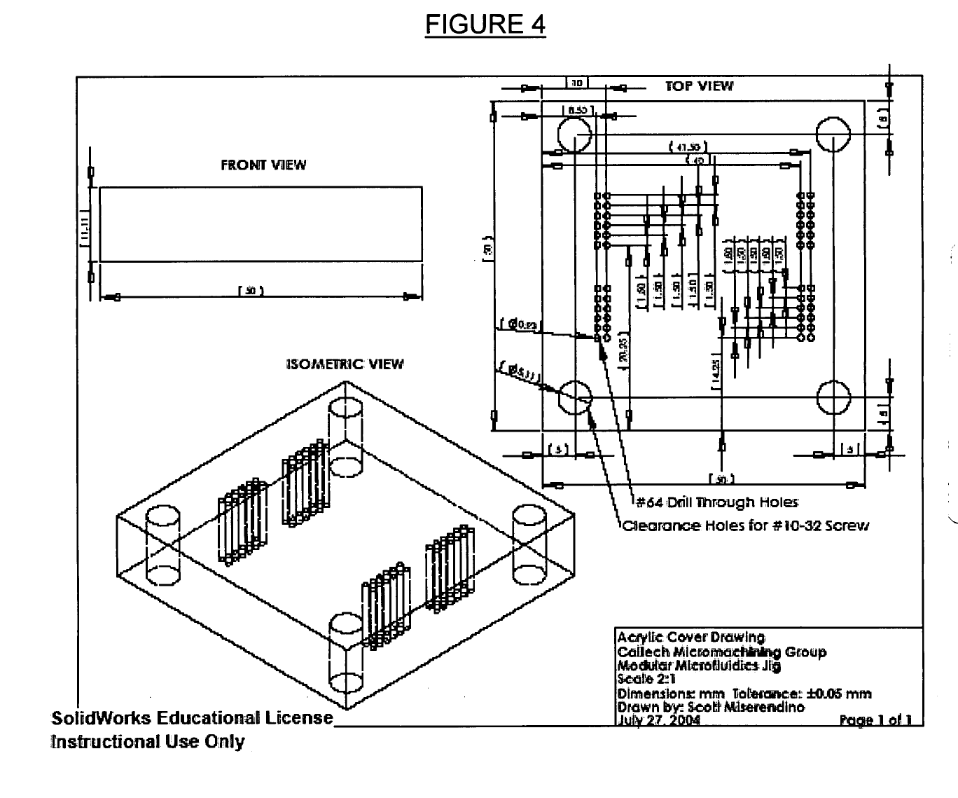

FIG. 4 provides an example of an acrylic cover.

IX. New FIGS. 14-30

Additional figures are provided to further describe embodiments.

FIG. 23 illustrates an assembly of the microfluidic modular packaging device and shows a similar view as FIG. 9. A more detailed description for this embodiment, a primary design. A jig body 001 has six external fluidic ports 004 on each of two opposite sides of the body of the jig (12 external fluidic ports total). The external ports 004 are provided with standard fluidic connectors 014 such as tubing, tubing nuts, and flangeless ferrules. The number of external ports used can be varied based on the application.

The top side of the jig body has a recess for placing the control die 003 (better seen in FIG. 9), and the recess is shaped and designed so that control die 003 can fit into it and also it can contain the module ports. Six internal fluidic ports 005 (not as readily seen in FIG. 23 as in FIG. 9) are provided on each side of the recess. Each of the internal fluidic ports is connected with one of the external fluidic ports through channels in the body of the jig.

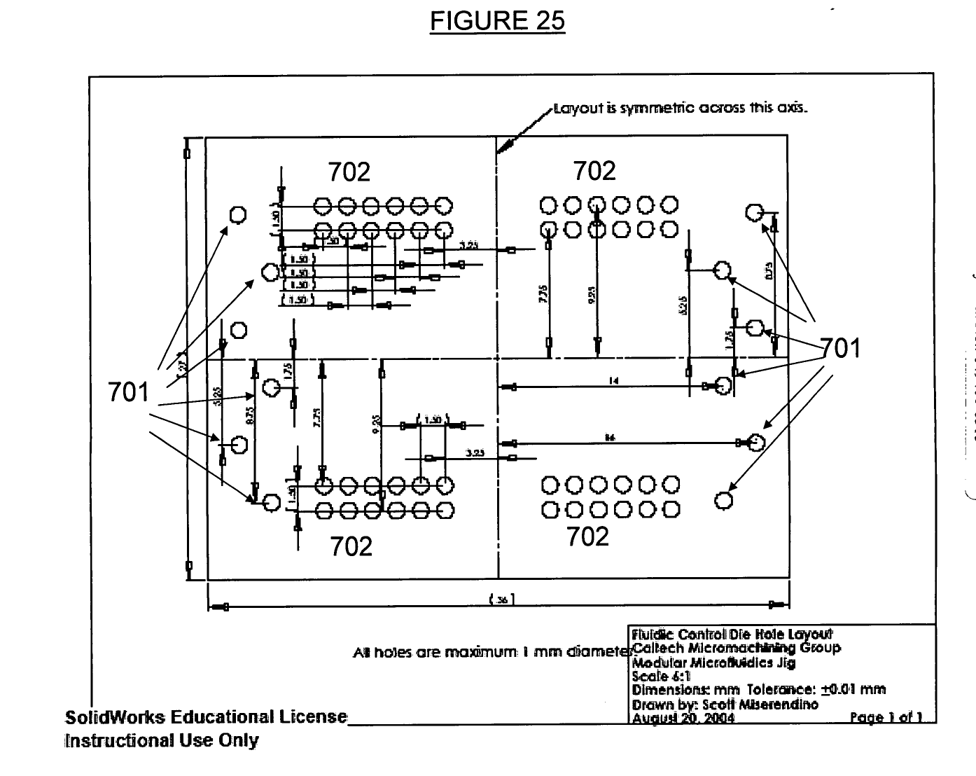

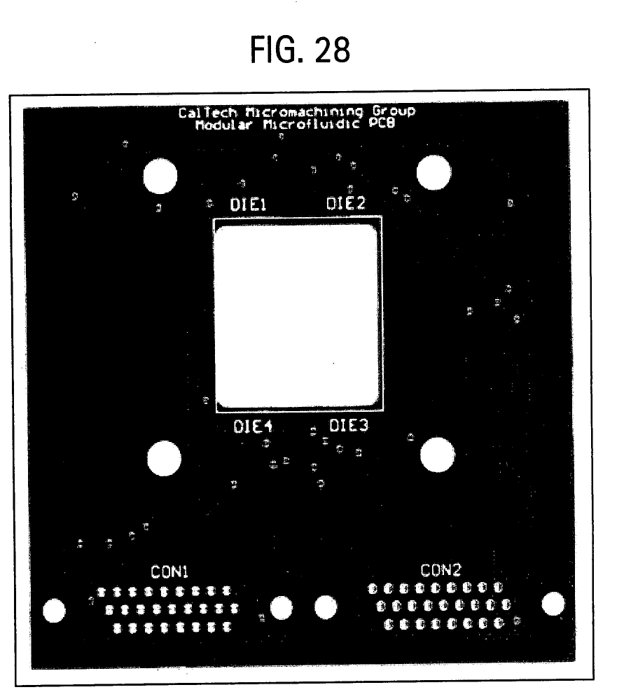

Up to four microfluidic modules 002 can be placed in on platforms in their respective module ports 006. The module ports 006 are positioned with respect to the recess so that contact pads (e.g., 601 in FIG. 28) of microfluidic modules 002 are accessible to electric probes when the control die 003 is placed on the recess. The movement of the microfluidic modules 002 in the module ports 006 is provided by regulating screws 007. Hexagonal standoffs 008 provide easy access to the screws 007. The electrical connection to the microfluidic modular packaging system is provided by high density D-subminiature right-angle connectors 011 located on the PCB board 010. The PCB board 010 has 4 sets of contact pads 016 on its back side, each for connecting to one microfluidic module. The contact pads 016 on the back side of the PCB board 010 are connected to the contact pads 601 of the module 002 using double sided probes. The PCB board 010 has a viewing window 013. The microfluidic modular packaging system also includes a transparent cover 009. The cover 009 has four sets of holes 015 for the double sided probes electrically connecting the PCB board 010 and the microfluidic modules 002. The components of the microfluidic modular packaging system are tightened together by tightening screws 012. When the system is assembled, the cover 009 compresses the control die 003 against the body of the jig 001 so that fluidic ports (‘through’ holes) 701 (see FIG. 25) of the control die 003 form a sealed fluidic connection with the internal fluidic ports 005 of the jig 001. To activate individual microfluidic module 002 for testing, it can be compressed against the control die 003 by turning the screw 007 so that fluidic ports 602 (FIG. 28) of microfluidic module form a sealed fluidic connection with the fluidic ports (‘through’ holes) 702 (FIG. 25) of the control die and the contact pads of the microfluidic module get electrically connected to the double sided electrical probes.

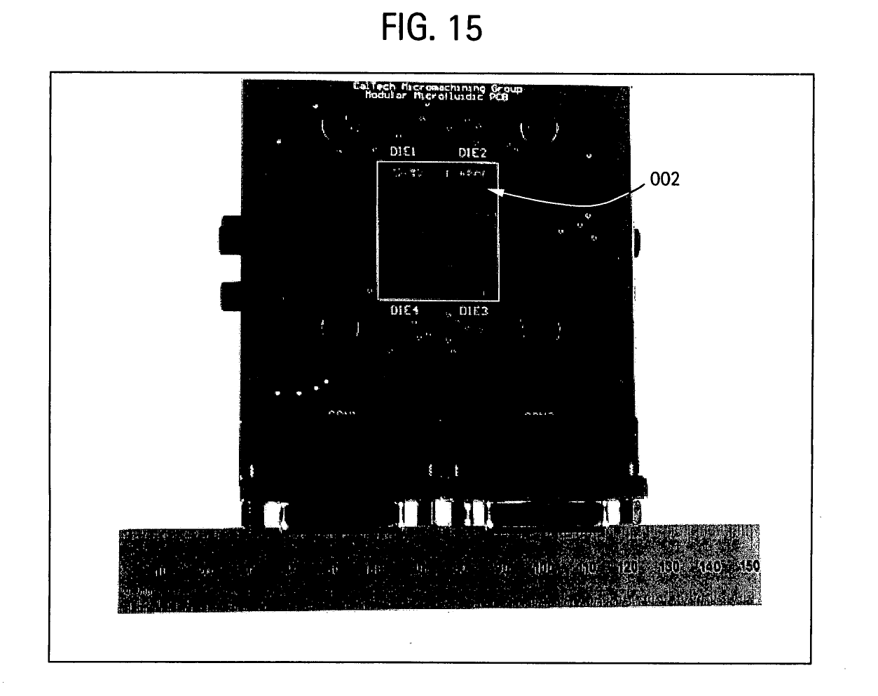

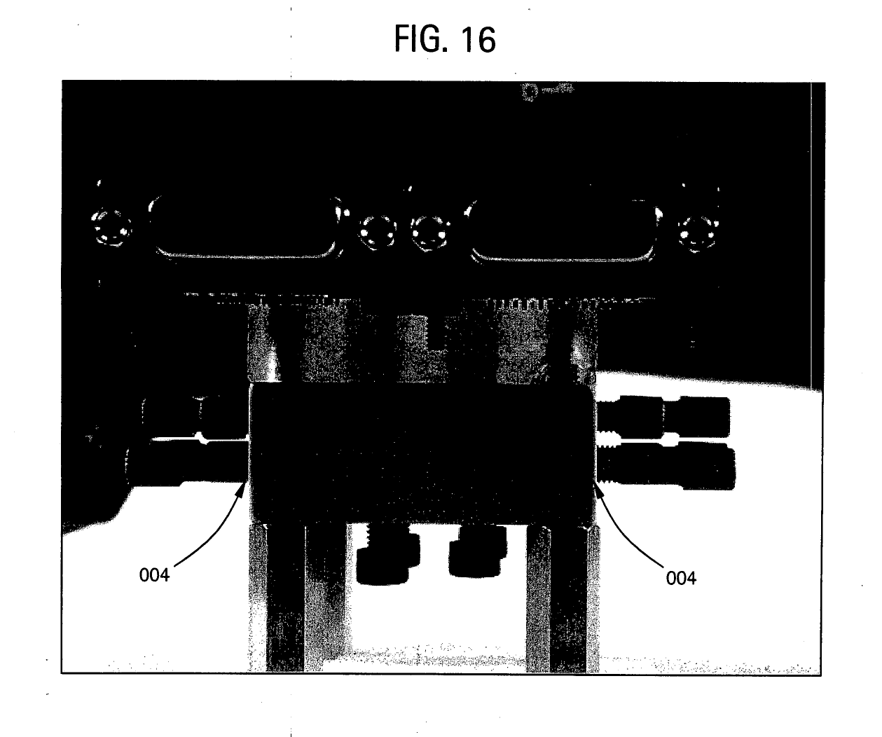

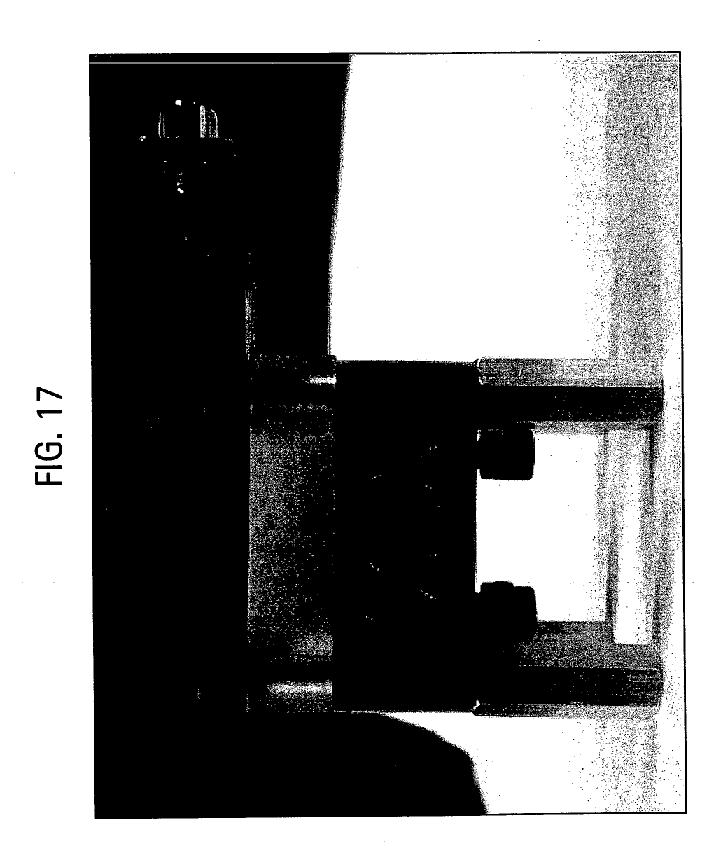

FIGS. 14-17 show photographs of an assembled microfluidic modular packaging system together with a 150 mm ruler bar to provide scale. FIG. 14 provides a perspective view. FIG. 15 shows a top view of the system. The individual microfluidic modules 002 are clearly visible through the viewing window 013 on the PCB board 010 and the acrylic cover 009. FIGS. 16 and 17 clearly show fluidic connections to the external fluidic ports 004 on the opposite sides of the jig 001.

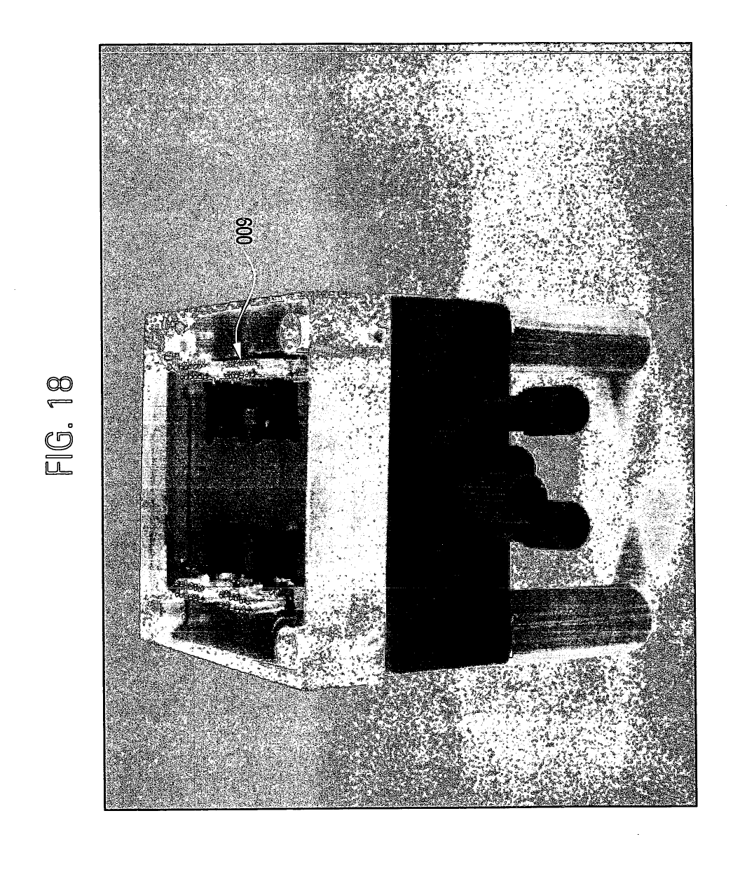

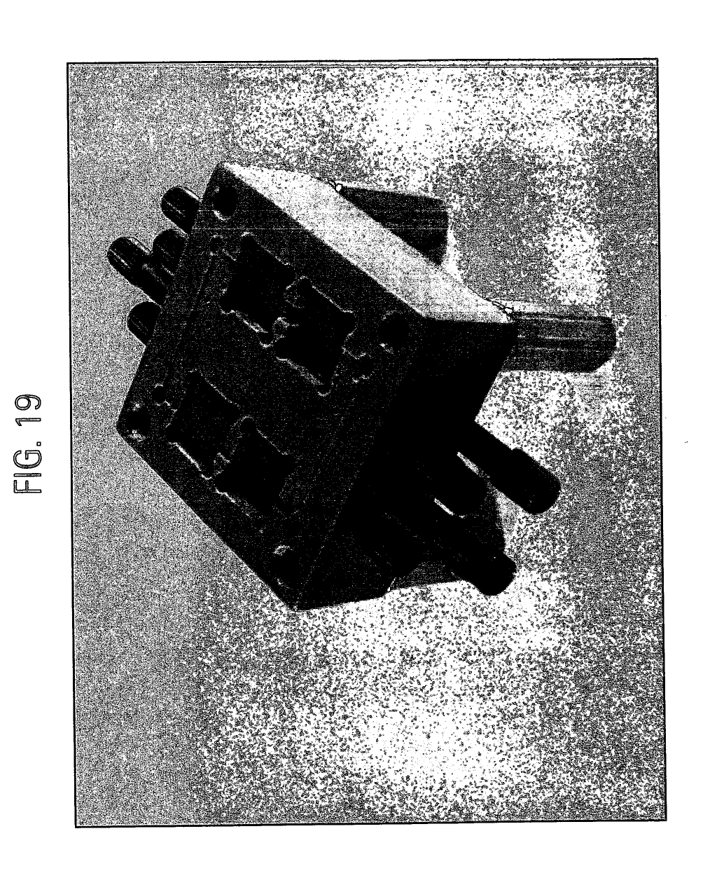

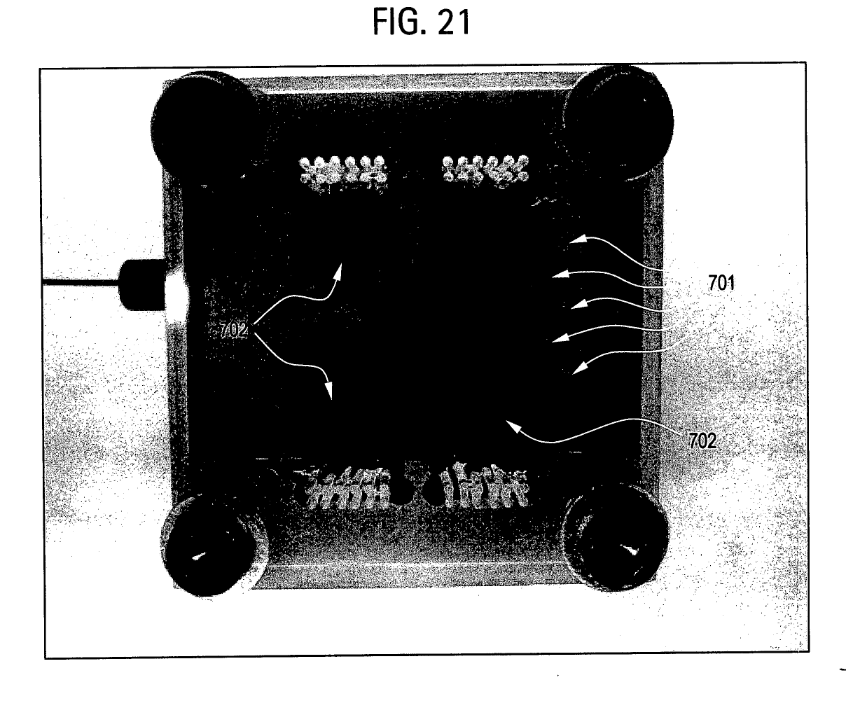

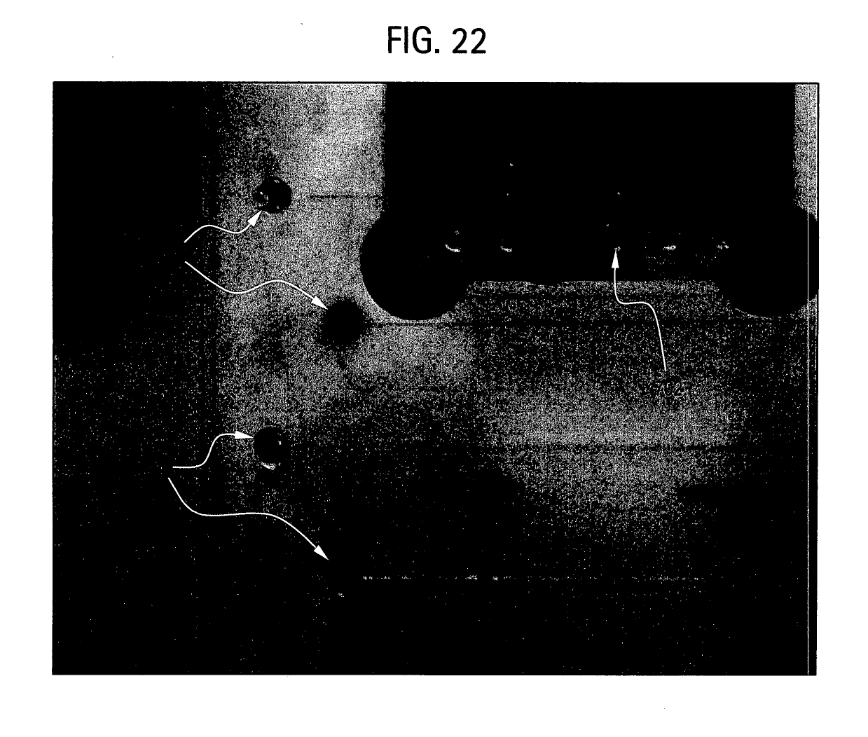

FIGS. 18, 21, 22, and 19 are photographs of the microfluidic modular packaging system illustrating some of its components. For example, FIG. 18 shows the sets of holes 009 extending through the thickness of the acrylic cover. These holes are for electrical probes connecting the PCB board and microfluidic modules. FIG. 19 is a top view of the system assembled without PCB board and microfluidic modules. This figure clearly shows a location of fluidic ports (‘through’ holes) on the control die. Four sets of fluidic ports 702 for fluidic connection with microfluidic modules are located over the module ports of the jig, while a layout of fluidic ports 701 match a layout of internal fluidic ports of the jig. On FIG. 21, one can also see regulating screws 007 (FIG. 23) for moving microfluidic modules in the module ports. FIG. 22 shows zoomed in view of fluidic ports on the control die. FIG. 19 shows the jig of the system with clearly visible platforms 017 for placing microfluidic modules. One of the platforms (upper) is lifted with respect to the others. In the fully assembled system, lifting up the platform can activate individual microfluidic module 002 for testing by compressing the module against the control die 003 (FIG. 23).

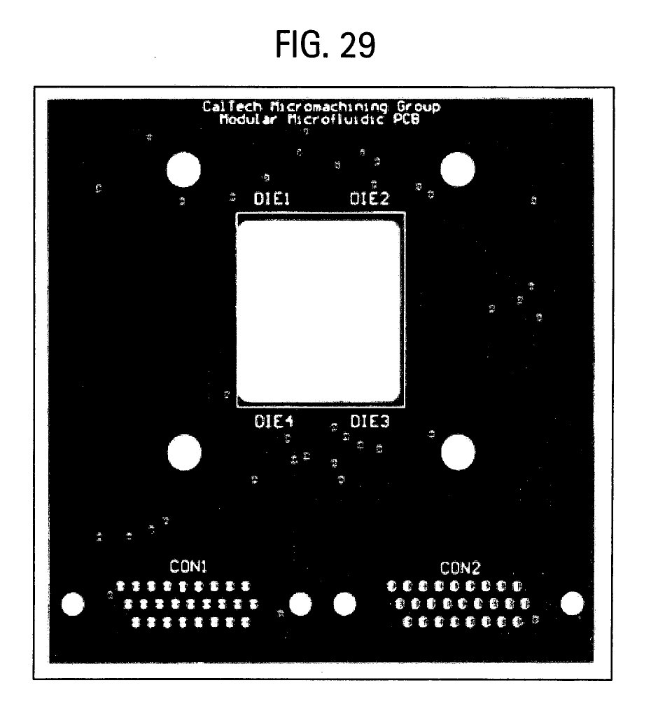

FIGS. 28 and 29 show a front and a back side of the PCB board 010 (FIG. 23). The back side of the PCB board has four sets of contact pads 016 for electrical connection to microfluidic modules. The PCB board has also two sets of contacts, labeled CON1 and CON2 in FIG. 28, for high density D-subminiature connectors.

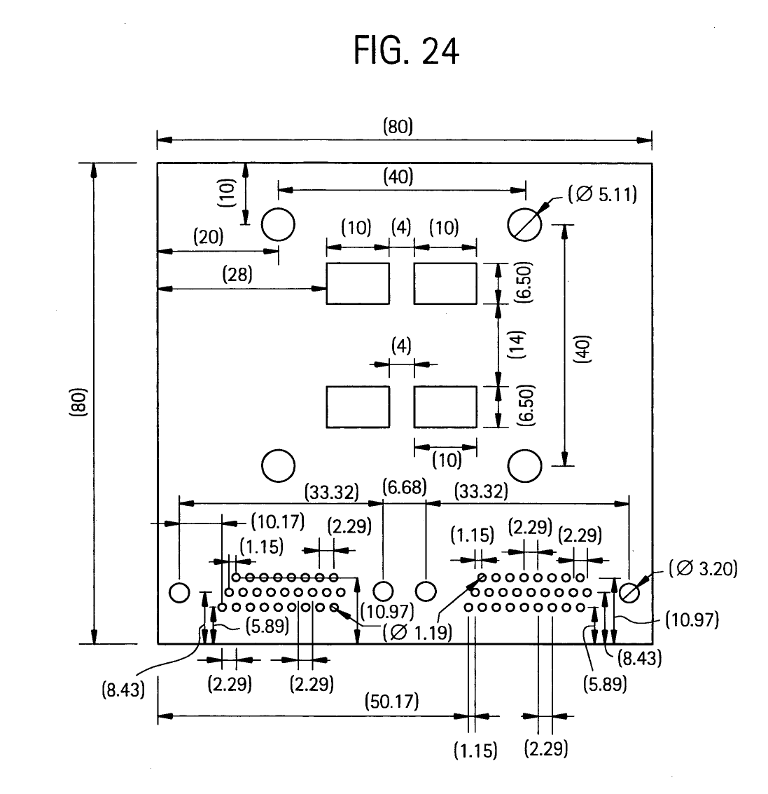

FIGS. 24 and 25 are additional blueprints and engineering drawings of components of the microfluidic modular packaging system.

FIG. 24 presents a hole and contact pad layout for the PCB board and is similar to FIG. 6. In particular, FIG. 6 shows a top view of the PCB board with 4 viewing ports, while FIG. 24 shows a bottom view of the PCB board with one viewing port.

FIG. 28 shows a hole and contact pad layout on the microfluidic module.

FIG. 25 shows a layout of fluidic ports (‘through’ holes) on the control die and is similar to FIG. 7.

FIG. 5 presents front, bottom and isomeric view of a platform for placing microfluidic module. The platform has a clearance hole for a screw that moves the microfluidic module within its module port.

FIG. 4 shows front, top and isomeric views of the acrylic cover. The acrylic cover has four clearance holes at the corners for tightening screws and four sets of holes for feeding through electrical probes connecting the contact pads of the PCB board to the contact pads of the microfluidic modules.

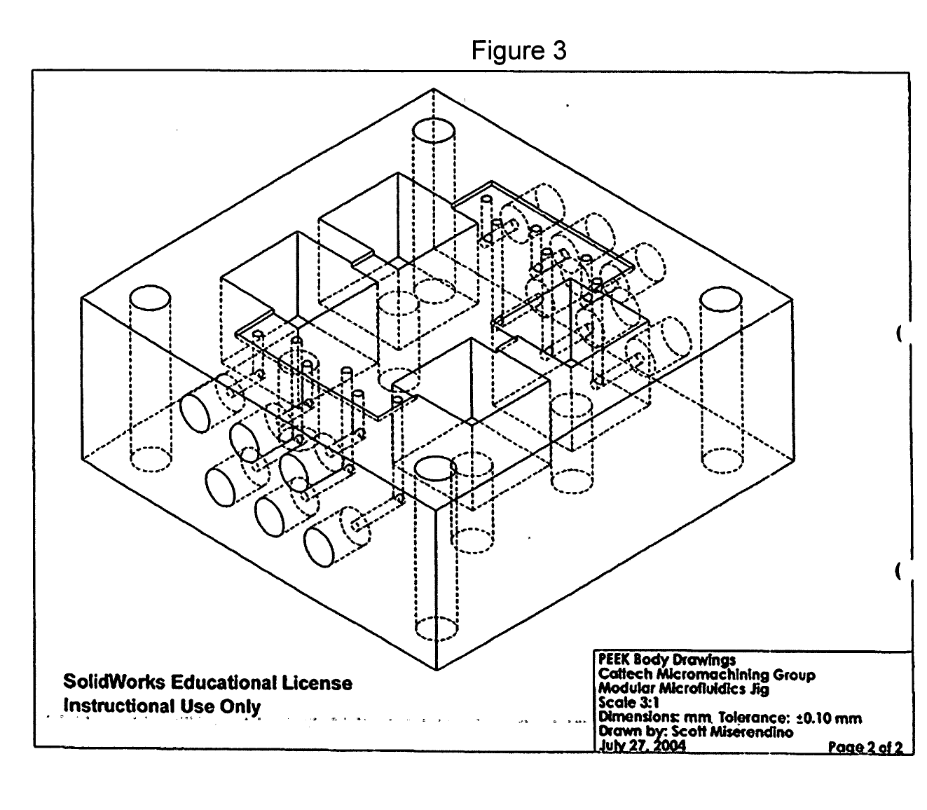

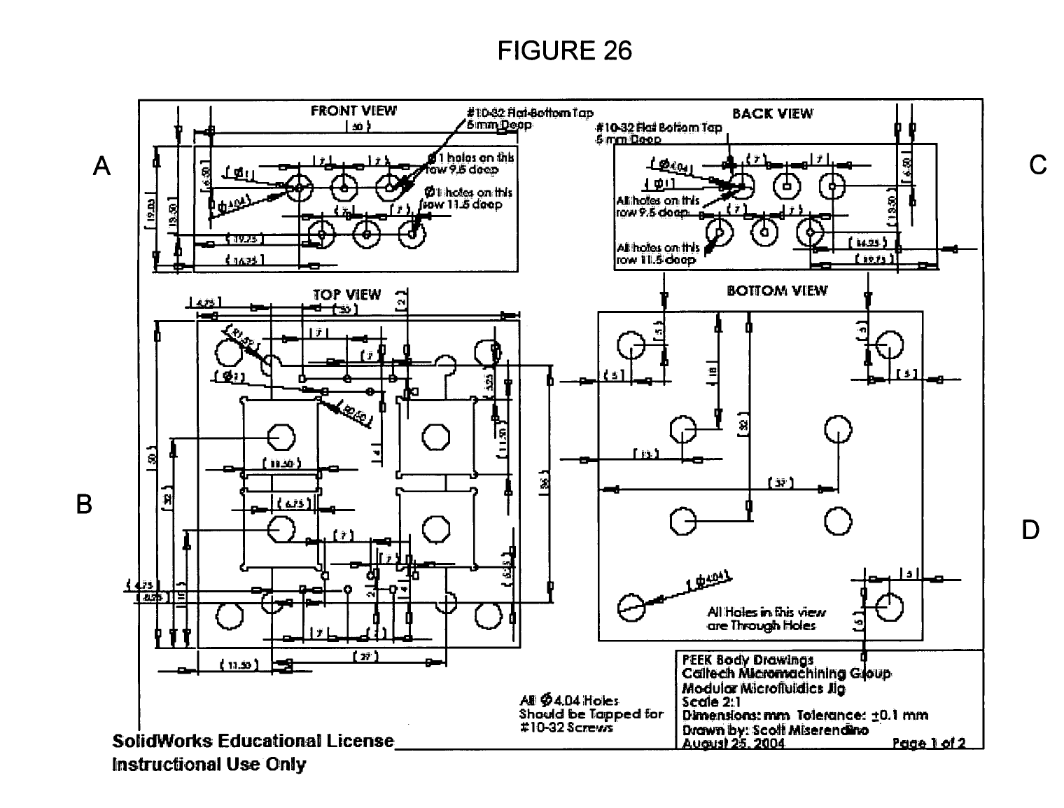

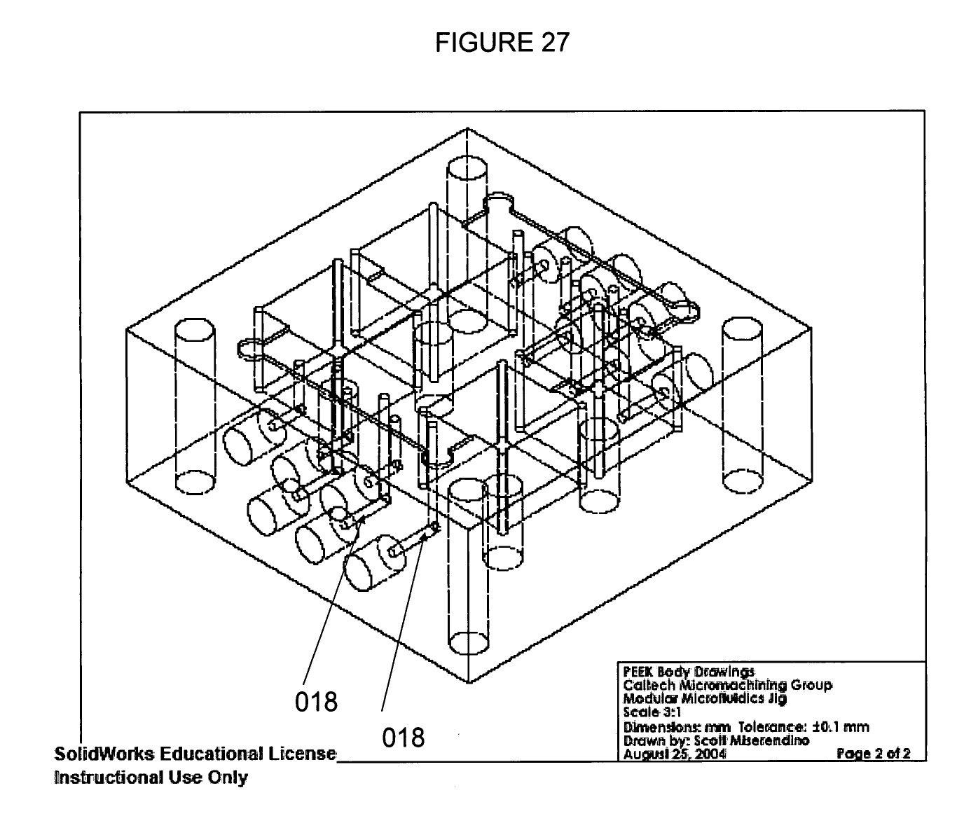

FIG. 26 shows respectively front, top, back, bottom and isomeric view of the jig's body, and is similar to FIG. 2. The front and the back views of the jig show the location of external fluidic ports of the body of the jig. On the top view, one can see four holes for tightening screws in the corners; a recess for placing the control die; four module ports for microfluidic modules. The module ports have holes in the bottom for screws regulating positions of the microfluidic modules. In particular, FIG. 26 shows that corners of the module ports can be rounded to make a movement of die platforms easier. FIG. 27, which is similar to FIG. 3, shows how each of external fluidic ports is fluidically connected with one of the internal fluidic ports through a channel in the body of the jig.

X. Methods of Making

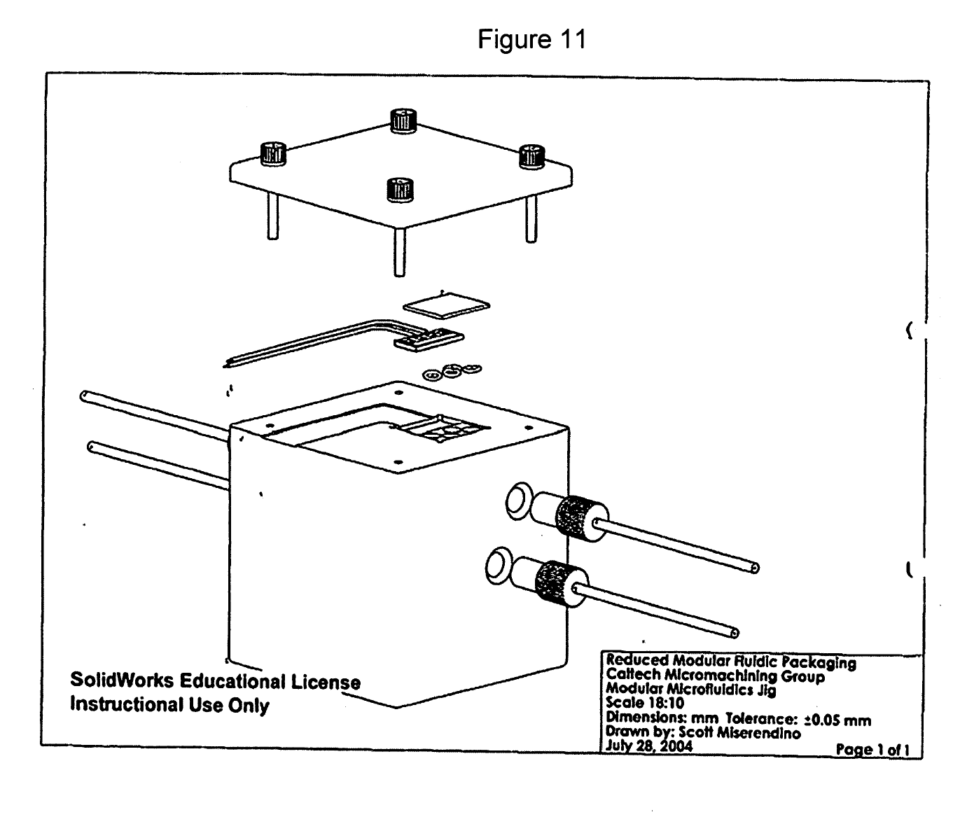

Another embodiment comprises methods of making a control die and microfluidic modules and methods of assembling component pieces. For example, a layout of a microfabricating process for a control die is illustrated of FIG. 11 (see also FIG. 1). The control die can be microfabricated by doing one or more of the following steps:

1) depositing a first layer of a polymer material such as parylene on a front surface of a substrate, the substrate can comprise glass, silicon, semiconductor material, metal or a polymer;

2) depositing a sacrificial layer of photoresist over the first layer of the polymer material by, for example, spin coating;

3) patterning the sacrificial layer of photoresist by, for example, photolithography to define microfluidic channels;

4) depositing a second layer of a polymer material such as parylene;

5) etching away the layers of polymer material in the areas of the front surface of the substrate free of the microfluidic channels;

6) planarizing the front surface of the substrate by, for example, depositing a layer of SU-8 and/or a layer of a photodefinable polymer such as PDMS using, for example, spin coating;

7) exposing the layer of the SU-8 and/or the layer of the photodefinable polymer to UV light through a mask to define microfluidic fluidic ports;

8) etching the second layer of the polymer material at the bottom of the microfluidic ports using, for example, oxygen plasma;

9) removing the sacrificial photoresist inside the microchannels by, for example, soaking the substrate in a photoresist stripper.

As mentioned above, the individual microfluidic modules can be microfabricated using a process similar to the one for the control die. Microfabricating of the individual microfluidic modules can further comprise depositing a thin layer of conducting material on the front surface of the substrate using, for example, E-beam or thermal evaporation; and patterning the thin layer of to form a plurality of contact pads using, for example, wet etching. The conducting material can be, for example, Ti, Pt, Au, Pd, Cr, Cu, Ag, carbon, graphite, pyrolyzed carbon or a combination thereof. If a material of a substrate is conducting like, for example silicon, microfabricating of the individual microfluidic modules can comprise depositing a electrically isolating layer before depositing the thin layer of conducting material. Planarizing the area around the microfluidic ports of the module can be achieved chemical mechanical polishing used in combination with or separately from depositing a layer of SU-8.

XI. Alternative Designs

Four alternative packaging designs are also provided. These designs are designated the stacked, wirebonding, clear top, and reduced modular microfluidic packaging designs. Each design variation has its advantages and disadvantages, but yet all meet the requirements of a modular microfluidic packaging system. The primary design is the most general and produces the fewest system limitations while providing the most benefits. These other designs are optimized for special need situations that users may face.

An example of the stacked design is provided in FIG. 10. The stacked design has the smallest form factor (as small as 2 cm×2 cm×2 cm without the tubing). It also boosts the smallest dead volume between devices which can be important if small on-chip pumps are needed. This design does not require a control die but does require each individual device to have both front and backside SU-8/PDMS gaskets. Another possible advantage is that this design is not limited in the number of devices that can be included in the stacks. Its major drawbacks compared to the primary design is its limited fluidic ports, lack of standardized electrical contacts, the need to soldier wires directly to individual devices, and difficulty in aligning the devices to one another. Manufacturing of individual devices in this design also requires through-wafer processing which can be both time consuming and expensive. There is no need for through-wafer process in the primary design.

An example of the reduced design in provided in FIG. 11. The reduced design has the second smallest form factor. It has the same number of fluidic inputs as the stacked system and similar dead volume yet has easier access to electrical connections either through the acrylic cover or by soldiering directly to the devices. Device visibility is also greatly enhanced over the stacked system and the need for through-wafer processing is eliminated. This design also eliminates the need for a separate control die necessary in the primary design. The major disadvantage of this design is that it is limited to just two devices.

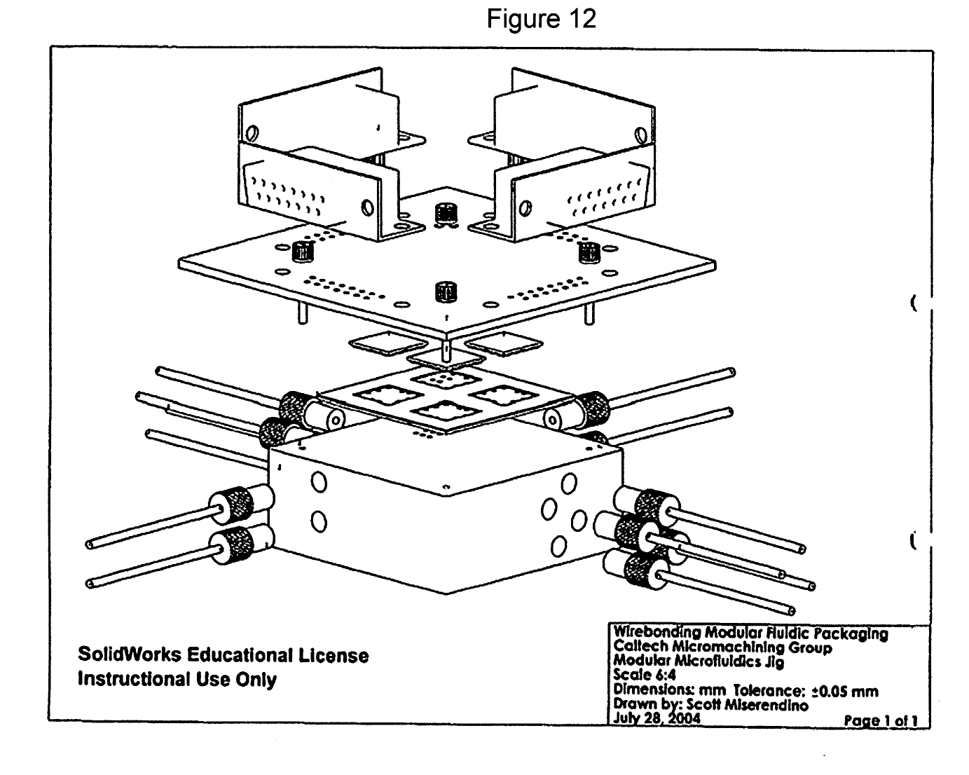

An example of the wirebonding design is provided in FIG. 12. The wirebonding design allows for wirebonds instead of probes to be used for electrical connection to the devices. Wirebonds can be more reliable than probes for long-term use. The disadvantages of this design are the wirebonds reduce the reuseability and reparability of the system since the device must be affixed to the PCB. This system also requires a PDMS channel and gasket component instead of a control die which can be more difficult to fabricate. Visibility of individual system components is very limited.

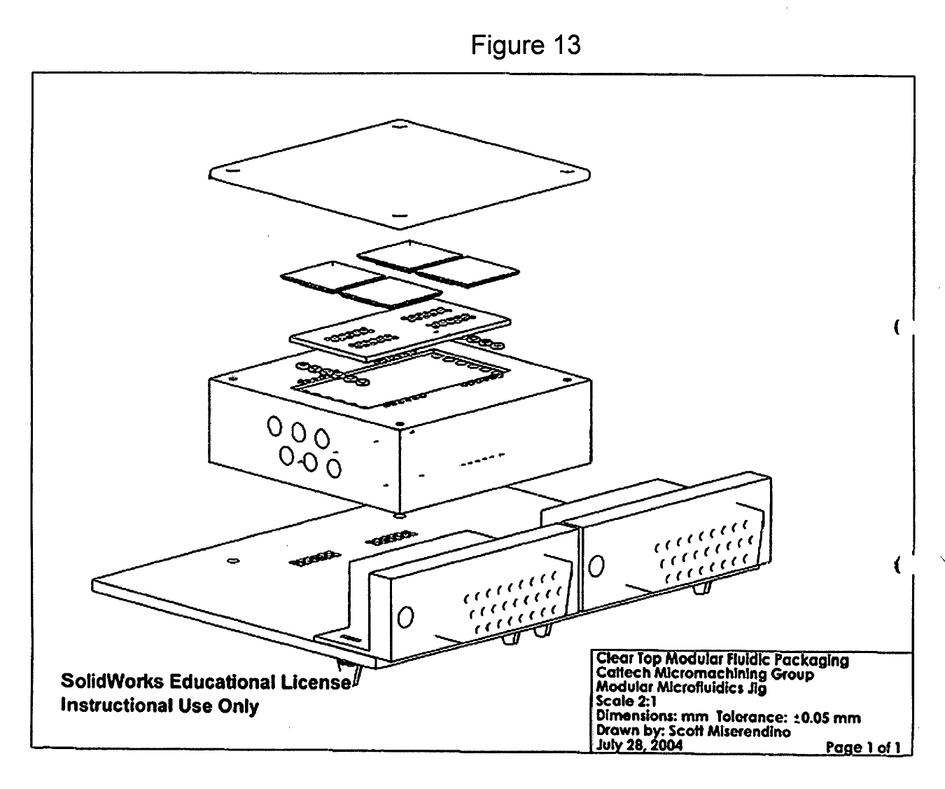

An example of the cleartop design is provided in FIG. 13. The clear-top system is the most similar of the alternative designs to the primary design. The major modification here is the electrical connections are made from below allowing a completely transparent acrylic cover to be used and maximizing device visibility. If devices are made on glass wafers than they will be easily visible without through-wafer processing, however, if the devices are made on silicon through-wafer processing is necessary to ensure maximum visibility. In any case, the control die must undergo through-wafer processing.

Additional possible variations and modifications include:

(i) Geometry of all components can be varied.

(ii) PDMS does not have to be used as the channel/gasket. Other materials may be appropriate.

(iii) Multiple modules may be stacked directly on top of one another provided the top module provides its own fluidic connections to the bottom one.

(iv) Control and generic die processing procedures and materials may be varied to allow different channel and device geometries, functions, and materials.

A design is described for a single module. Here, provided is a microfluidic system comprising: (A) a jig comprising: (i) external fluidic ports, (ii) internal fluidic ports, and (iii) a jig body comprising a plurality of channels providing fluidic communication between said external and internal fluidic ports; (B) a microfluidic die comprising: (i) a substrate having a front surface and a back surface, (ii) microfluidic ports on the front surface, wherein said microfluidic ports do not extend from said front surface to said back surface, and (iii) a plurality of channels on the front surface, wherein said channels provide microfluidic communication between said microfluidic ports; and wherein said microfluidic die is disposed on the jig so that said microfluidic ports of the die match internal fluidic ports of the jig.

XII. Applications

Also provided is methods of using the systems described herein in applications. The microfluidic modular packaging system of the present invention can be used for bringing the fluid to individual micromodule scale (picoliters) from the macro-scale (microliters). The microfluidic modular packaging system can be used in testing components for applications such as liquid chromatography, gas chromatography, micro high performance liquid chromatography, electrophoresis, cell sorting, electrospray ionization, small volume biological sample preparation (e.g. cell lyses, DNA extraction, DNA purification, on-chip PCR) or a combination thereof. The components fabricated on the microfluidic modules can include but not limited to, for example, electrochemical detectors, electrochemical cells, electrospray ionization nozzles, microfluidic channels, microfluidic valves, microfluidic mixers, microfluidic pumps, microfluidic filters, chromatography columns, sensors, microheaters, microcoolers or any combination thereof.

Although the foregoing refers to particular preferred embodiments, it will be understood that the present invention is not so limited. It will occur to those of ordinary skill in the art that various modifications may be made to the disclosed embodiments and that such modifications are intended to be within the scope of the present invention.

All of the publications, patent applications and patents cited in this specification are incorporated herein by reference in their entirety.

What is claimed is:

1. A microfluidic modular packaging system comprising:
a packaging jig comprising a body, at least two module ports for placing microfluidic modules, at least one external fluidic port, and at least one internal fluidic port;
at least two die platforms adapted to fit into the module ports and move the microfluidic modules,
at least one fluidic control die;
at least one circuit board, and
at least one cover.

2. The system according to claim 1, further comprising at least one translation stage for moving the die platforms with respect to the packaging jig.

3. The system according to claim 1, wherein the packaging jig comprises at least four module ports, at least 12 external fluidic ports, and at least 6 internal fluidic ports, and wherein said body comprises a plurality of channels providing fluid communication between said external and internal fluidic ports and not providing fluid communication between said microfluidic modules.

4. The system of claim 1, comprising at least four die platforms which do not provide fluid communication to the microfluidic modules.

5. The system according to claim 1, wherein the fluid control die has a front surface and a back surface, wherein the front surface of said control die comprises a plurality of microchannels providing fluid communication between said at least two modules and/or between said microfluidic modules and the internal fluidic ports of said jig.

6. The system according to claim 1, wherein the circuit board is a printed circuit board comprising external electrical connectors and internal electrical connectors, wherein said internal connectors are electrically coupled to said microfluidic modules when disposed in said ports.

7. The system according to claim 1, wherein the cover is a transparent cover to allow visibility of the operation of the microfluidic modules when disposed in said ports and further comprises holes to allow for electrical communication between the microfluidic modules and the control die.

8. The system of claim 1, further comprising at least two microfluidic modules.

9. A system of claim 1, further comprising at least one translation stage for moving the die platforms with respect to the packaging jig;
wherein the packaging jig comprises at least four module ports, at least 12 external fluidic ports, and at least 6 internal fluidic ports, and wherein said body comprises a plurality of channels providing fluid communication between said external and internal fluidic ports and not providing fluid communication between said microfluidic modules;
wherein the system comprises at least four die platforms which do not provide fluid communication to the microfluidic modules;
wherein the fluid control die has a front surface and a back surface, wherein the front surface of said control die comprises a plurality of microchannels providing fluid communication between said at least two modules and/or between said microfluidic modules and the internal fluidic ports of said jig;
wherein the circuit board is a printed circuit board comprising external electrical connectors and internal electrical connectors, wherein said internal connectors are electrically coupled to said microfluidic modules when disposed in said ports;
and wherein the cover is a transparent cover to allow viewing the microfluidic modules when disposed in said ports and further comprises holes to allow for electrical communication between the microfluidic modules and the control die.

10. The system of claim 9, further comprising at least two microfluidic modules which provide an HPLC system.

11. A packaging jig for a microfluidic modular packaging system comprising
(i) a packaging jig body having module ports for placing said microfluidic modules;
(ii) external fluidic ports; and
(iii) internal fluidic ports;
wherein said body comprises a plurality of channels providing fluid communication between said external and internal fluidic ports and not providing fluid communication between said microfluidic modules.

12. The jig of claim 11, further comprising die platforms disposed in the module ports.

13. The jig of claim 12, further comprising a control die disposed on the jig having a front surface and a back surface, wherein the front surface of said control die comprises a plurality of microchannels providing fluid communication between said two or more modules and/or between said microfluidic modules and the internal fluidic ports of said jig.

14. The jig of claim 13, further comprising a cover disposed on the control die.

15. The jig of claim 14, further comprising a circuit board disposed on the cover.

16. The jig of claim 11, further comprising microfluidic modules disposed in said module ports.

17. The packaging jig of claim 12, further comprising translational stages, wherein said stages provide movement of said die platforms within said module ports with respect to said body.

18. The packaging jig of claim 13, wherein said control die does not comprise side to side fluidic holes, and wherein the front surface of said control die comprises a polymer gasket layer comprising photodefinable polymer.

19. The packaging jig of claim 18, wherein said polymer gasket layer further comprises photoresist or epoxy.

20. The packaging jig of claim 17, wherein each of said translational stages comprises a screw and a platform for microfluidic module.

21. The packaging jig of claim 11, further comprising the microfluidic modules disposed in the module ports which have a front surface and a back surface, said front surface comprises a plurality of microchannels, a plurality of electrodes or a combination thereof.

22. The packaging jig of claim 15, wherein the circuit board is a printed circuit board comprising external electrical connectors and internal electrical connectors, said internal connectors are electrically coupled to said microfluidic modules.

23. The packaging jig of claim 16, wherein said internal connectors are electrically coupled to microfluidic modules in said module ports using double ended probes.

24. The packaging jig of claim 23, wherein the double ended probes are pogo pegs.

25. A microfluidic system comprising:
(A) a jig comprising: (i) external fluidic ports, (ii) internal fluidic ports, and (iii) a jig body comprising a plurality of channels providing fluidic communication between said external and internal fluidic ports;
(B) a microfluidic die comprising: (i) a substrate having a front surface and a back surface, (ii) microfluidic ports on the front surface, wherein said microfluidic ports do not extend from said front surface to said back surface, and (iii) a plurality of channels on the front surface, wherein said channels provide microfluidic communication between said microfluidic ports; and wherein said microfluidic die is disposed on the jig so that said microfluidic ports of the die match internal fluidic ports of the jig.
